(19) United States
(12) Patent Application Publication
(10) Pub. No.: US 2014/0166503 A1
(43) Pub. Date: Jun. 19, 2014

(54) METHOD AND DEVICE FOR MEASURING HEMATOCRIT

(71) Applicant: BROADMASTER BIOTECH CORP., New Taipei City (TW)

(72) Inventors: Yao-Chun Lai, New Taipei City (TW); Yi-Lung Chen, New Taipei City (TW); Chien-Hung Lai, New Taipei City (TW); Po-Hao Lin, New Taipei City (TW); Ya-Sian Lin, New Taipei City (TW); Shih-Jen Lu, New Taipei City (TW); Chih-Wei Liu, New Taipei City (TW)

(73) Assignee: BROADMASTER BIOTECH CORP., New Taipei City (TW)

(21) Appl. No.: 13/712,987

(22) Filed: Dec. 13, 2012

(51) Int. Cl. G01N 27/327

(52) U.S. Cl. CPC G01N 27/3275
USPC 205/782; 204/403.01

(57) ABSTRACT

An approach is provided for a method and device for measuring Hematocrit (Hct) are disclosed that measures current variations from reactions of Electrochemistry on the electrodes. The method comprises acts of giving a blood sample on a pair of electrodes, obtaining a response current by providing a voltage on the electrodes, and determining an Hct value from the obtained current based on a predetermined rule. Therefore, the present disclosure provides higher reliable and precise measurement compared to the conventional measuring apparatus.

### FIELD OF THE INVENTION

Embodiments of the present invention relate to a detecting method and device, and especially toward a method for measuring hematocrit (Hct) and a detecting device applying the method.

### BACKGROUND

Hematocrit (Hct), also known as packed cell volume (PCV), refers to a volume percentage (%) of red blood cells in blood. Hct is conventionally used as a target index to diagnosis anemia or cardiovascular disease. However, Hct is also an important factor to influence the blood sugar level in a blood sugar test. Therefore, the Hct of a testee should be detected first to calibrate blood sugar in the blood sugar test to increase the accuracy of the test.

A conventional hematocrit test is operated by an examiner, a clinical staff, or a specific machine, such as a hemocytometer. However, manual examination usually has procedure complexity and is time consuming, and machine operation has disadvantage of higher purchase cost and more maintenance requirements.

Therefore, there is a need to develop a method or a mechanism to improve the accuracy and reliability of a hematocrit test, and to simplified operation procedure to proceed the test.

### SOME EXEMPLARY EMBODIMENTS

These and other needs are addressed by the present invention, wherein an approach is provided for a method and device for measuring hematocrit (Hct) device.

According to one aspect of an embodiment of the present invention, a method for measure the hematocrit comprises steps of adding a blood sample on a pair of detecting electrode, obtaining a response current by providing a voltage to the pair of detecting electrode; and finally obtaining a hematocrit value according to a predetermined rule and the response current.

According to another aspect of an embodiment of the present invention, a device for measuring a hematocrit comprises a detector and a measuring apparatus. The detector comprises a pair of detecting electrode having a receiving portion and a contacting portion. The receiving portion is used to accept a blood sample. The measuring apparatus connects to the contacting portion of the detector and provides a voltage to the contacting portion based on a predetermined rule to measure a Hematocrit of the blood sample.

Therefore, the embodiment of the present invention provides a simple operating measuring method and device for obtaining an accurate and reliable result than a conventional test trip.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a schematic view of an embodiment of a hematocrit detecting device in accordance with the present invention.

FIG. 2 is an exposure view of a detector of an embodiment of the hematocrit detecting device in accordance with the present invention.

FIG. 3 is a an exposure view of a detector of another embodiment of the hematocrit detecting device in accordance with the present invention.

FIG. 4 is a schematic view of an embodiment of the hematocrit detecting device in accordance with the present invention.

FIGS. 5A to 5C show the relationship between response current and time in different embodiments.

FIG. 6 is a flow chart illustrates the procedure of the hematocrit detection method in accordance with the present invention.

### DESCRIPTION OF THE PREFERRED EMBODIMENT

A method for measuring the hematocrit is disclosed. In the following description, for the purposes of explanation, numerous specific details are set forth in order to provide a thorough understanding of the present invention. It is apparent, however, to one skilled in the art that the invention may be practiced without specific details or with an equivalent arrangement. In other instances, well-known structures and devices are shown in block diagram form in order to avoid unnecessarily obscuring the embodiments of the present invention.

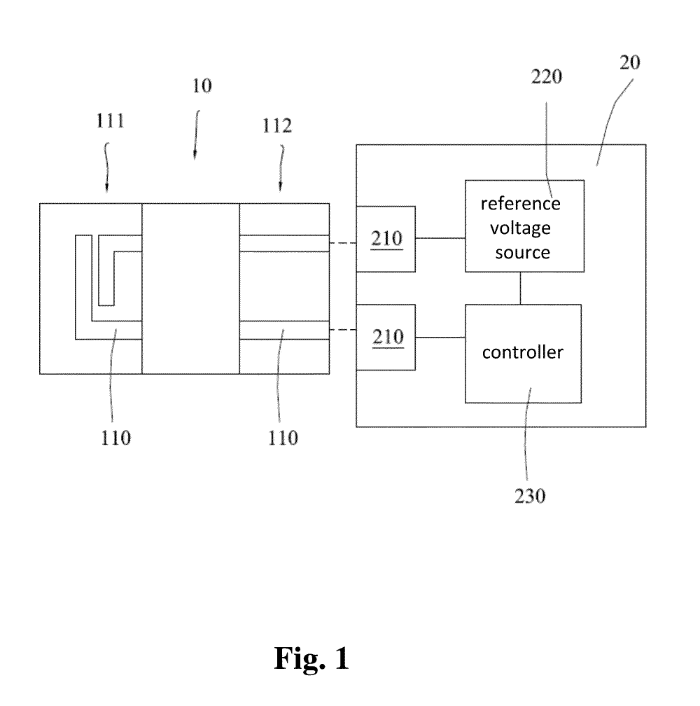

With reference to FIG. 1, FIG. 1 is a schematic view of an embodiment of a hematocrit detecting device in accordance with the present invention. The hematocrit detecting device comprises a detector 10 and a measuring apparatus 20. The detector 10 comprises a pair of detecting electrodes 110 having a receiving portion 111 and a contacting portion 112. The receiving portion 111 is configured for accepting a blood sample. The measuring apparatus 20 connects to the contacting portion 112 of the pair of the detecting electrode 110 and provides a voltage to the contacting portion 112 based on a predetermined rule to measure a hematocrit of the blood sample.

The measuring apparatus 20 comprises a pair of connector 210, a reference voltage source 220 and a controller 230. Each connector 210 has a first terminal that is configured to connect with the contacting portion 112. The reference voltage source 220 connects to a second terminal of one of the connectors 210, and provides the voltage for measurement. The controller 230 is connected to a second terminal of another connector 210 and the reference voltage source 220, and receives a response current from the conducted detector 10 for measuring the hematocrit of the blood sample.

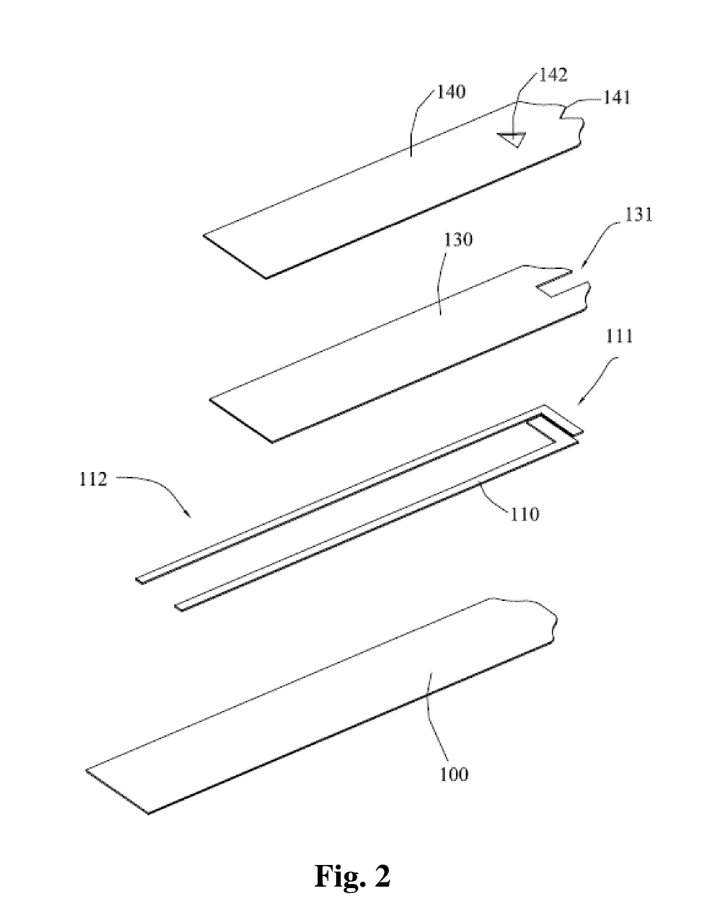

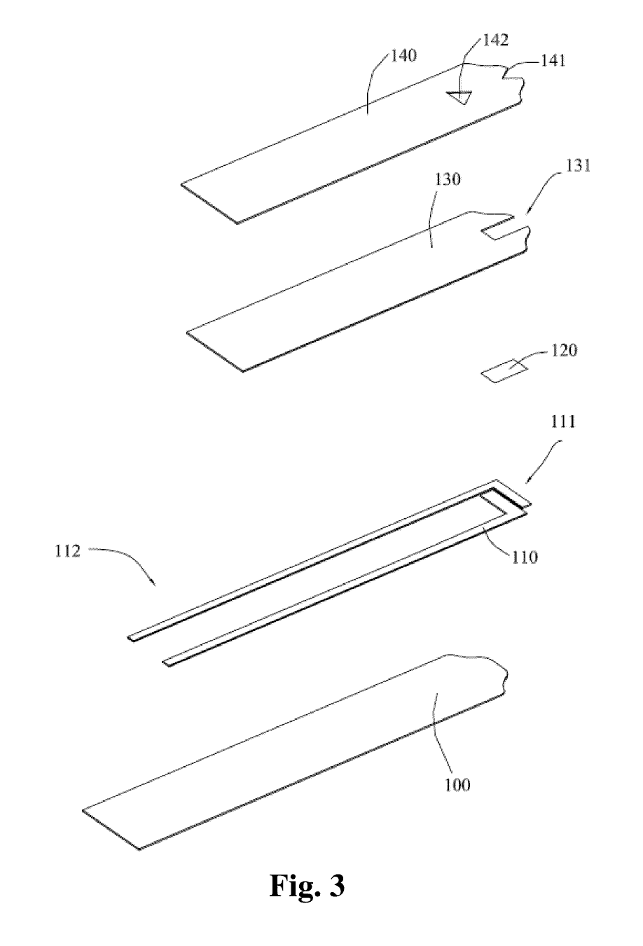

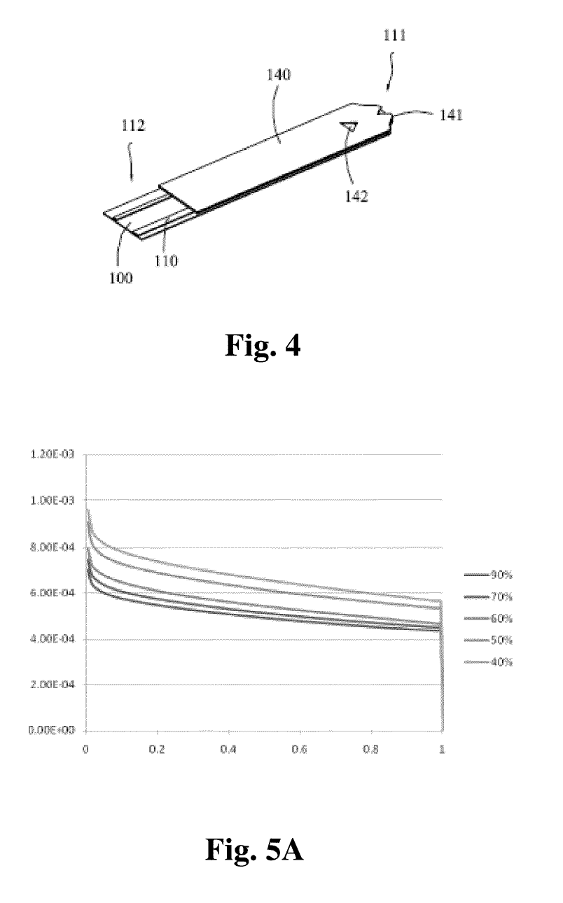

With reference to FIGS. 2 to 4, FIG. 2 is an exposure view of a detector of an embodiment of the hematocrit detecting device in accordance with the present invention. FIG. 3 is an exposure view of a detector of another embodiment of the hematocrit detecting device in accordance with the present invention. FIG. 4 is a schematic view of an embodiment of the hematocrit detecting device in accordance with the present invention. In FIG. 3, an embodiment of the detector 10 is designed as a test strip, comprising a substrate 100, a pair of detecting electrode 110, an insulating piece 130 and a cover 140. The detecting electrodes 110 are mounted on the substrate 100. The insulating piece 130 comprises an opening 131 and is placed on the substrate 100, partially covers above the detecting electrodes 110, which makes a portion of rear ends of the detecting electrodes 110 exposed. The opening 131 is positioned at a front end of the insulating piece 130, which makes a portion of front end of the detecting electrode 110 being exposed.

Accordingly, the receiving portion 111 of the pair of detecting electrode 110 is defined as the portion exposure by the opening 131. The contacting portion 112 is defined as the detecting electrode 110 positioned at the rear end of substrate 100 which is not covered by the insulating piece 131.

With reference to FIG. 4, in another embodiment, the detector 10 further comprises a surfactant 120. The surfactant 120 is placed on the substrate 100 and covers the receiving portion 111 of the detecting electrode 110.

The cover 140 is disposed on the insulating piece 130, and comprises a conductive concave 141 and a conductive hole 142. The conductive concave 141 is formed on a front end of the cover 140 and is configured for overlapping with the opening 131 of the insulating piece 130. The conductive hole 142 is formed on the cover 140 correspond to the opening 131 of the insulating piece 130 that forms a pathway.

In an embodiment, the substrate 100 is an insulating substrate and is made of non-conductive material selected from the group consists of: polyethylene terephthalate (PET), Polyvinylchloride (PVC), Flame Resistant glass fiber (FR-4), phosphatidylcholine (PC). Polyethylene (PE), Polypropylene (PP), Polystyrene (PS), Polyester sulphone, ceramic plate (CEM) and glass. The material of the insulating piece 130 and the cover 10 does not have special limitation and can be the same material used as the substrate 100.

In an embodiment, the pair of detecting electrode 110 is made of a conductive material and is not limited as a metal. The pair of detecting electrode 110 might be sputtered, evaporated or printed as any pattern to form an electrode pattern on the substrate 100. As shown in FIG. 2, the pair of detecting electrode 110 comprises two opposite L-shaped electrodes. Two shorter edges are parallel and are disposed on the front end of the substrate 100. Two longer edges also are parallel and are extended to the rear end of the substrate 100.

A blood sample is collected by a lancet and is dropped onto the conductive hole 142. The conductive pathway between conductive hole 142 and the opening 131 of the insulating piece 130 exists a capillary action to guide the blood sample flowed from the opening 131 to the detector 10. Therefore, the blood sample contacts with the pair of detecting electrode 110 covered with the surfactant 120. The measuring apparatus 20 is turned on by connecting the contactor 112 of the pair of detecting electrode 110 and the connectors 210 of the measuring apparatus 20.

The controller 230 drives the reference voltage source 220 for providing a voltage between the pair of detecting electrode 110. The voltage creates an electrochemical reaction while contacting with the surfactant 120 and/or the blood sample to form a response current. The response current changes with the hematocrit of the blood sample. The controller 230 reads the response current to obtain the hematocrit of the blood sample. During a period of time, the controller 230 has capability to distinguish hematocrit of variant blood samples by different response current.

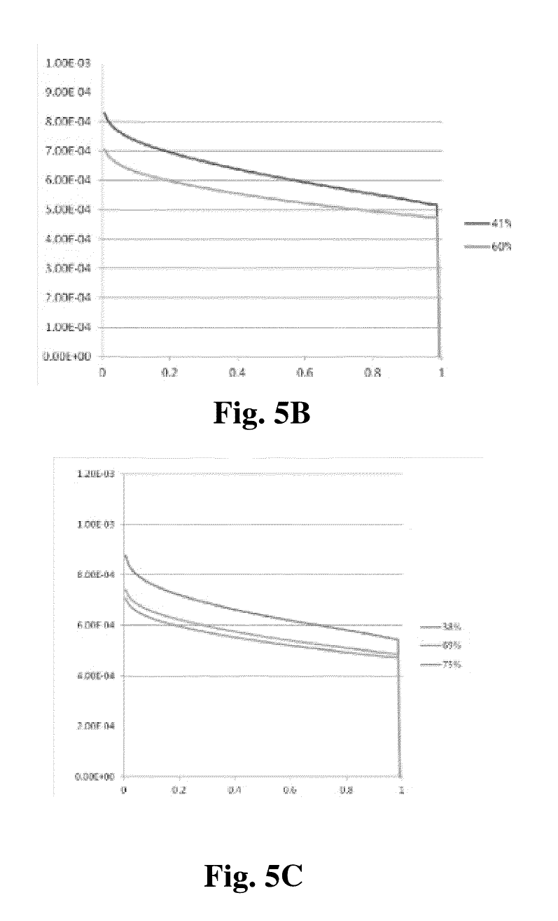

With reference to FIGS. 5A to 5C, FIGS. 5A to 5C show the relationship between response current and time in different embodiments. As shown in the FIG. 5A, the response current of blood sample without adding the surfactant is decreasing with increased hematocrit, that is, in the condition of zero surfactant added, the response current of blood sample with 40% hematocrit is higher than the blood sample with 30% hematocrit, and so on. The variation of response current is relative weak in the blood sample with higher hematocrit. Therefore, as shown in FIG. 5B, in the condition of the surfactant is added, the response current of blood sample with hematocrit by 41% is higher than by 60%. Also, the FIG. 5C shows the relationship between response current and time while detecting blood samples with different hematocrit values by 38%, 69%, and 75%.

Accordingly, it is noted that the surfactant 120 both has characteristic of hydrophobic and hydrophilic to increase the detection stability while being homogenous spread in the plasma.

In an embodiment, the surfactant 120 is selected from the group consists of cetyltrimethylammonium bromide (CTAB)—Triton X-100, TWEEN 20, TWEEN 40, TWEEN 60, Span 20, Carboxymethyl cellulose (CMC), sodium cholate and Sodium Dodecyl Sulphate (SDS).

In another embodiment, the voltage be inputted into the pair of detecting electrodes 110 is between 1 and 3 volts, and the period of time is between 0.01 and 1 second. In order to increase detection accuracy and efficiency to obtain a precise hematocrit value, the controller 230 has to be set in advance (for example, pre-set up by an electrochemistry aperture) and stores data of different values of hematocrit to calculate the corresponding response current.

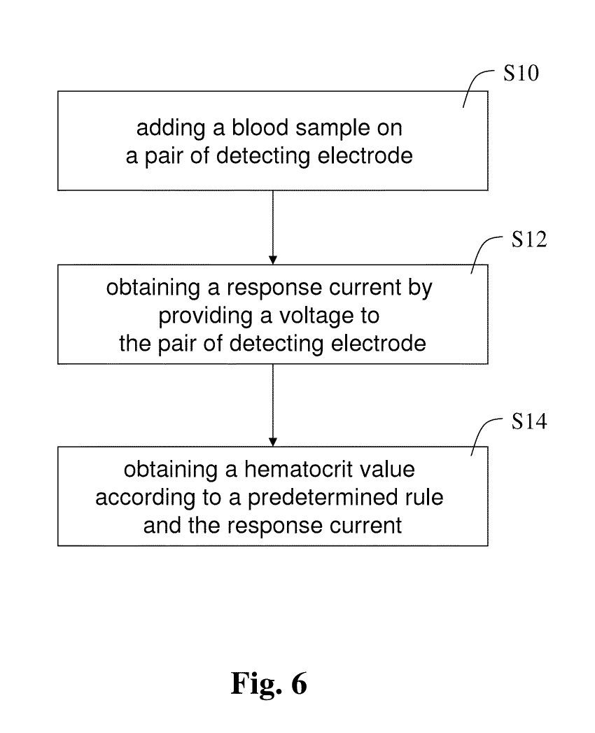

With reference to FIG. 6, FIG. 6 is a flow chart illustrates the procedure of the hematocrit detection method and comprises steps of S10 adding a blood sample on a pair of detecting electrode; S12 obtaining a response current by providing a voltage to the pair of detecting electrode; and S14 obtaining a hematocrit value according to a predetermined rule and the response current.

In the step S10 of adding a blood sample on a pair of detecting electrode is based on the type of the detecting electrode. In an embodiment, the blood sample is added on a pair of detecting electrode with a spread surfactant.

The predetermined rule comprises multiple hematocrit data. The hematocrit data at least comprises multiple hematocrit values detected under different voltages that establish relationships between hematocrit values and the response currents.

Accordingly, compared with a conventional detection, the present invention provides a simple operating measuring method to obtain an accurate and reliable result.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for measuring a hematocrit comprising steps of:
adding a blood sample on a pair of detecting electrode;
obtaining a response current by providing a voltage to the pair of detecting electrode; and
obtaining a hematocrit value according to a predetermined rule and the response current.

2. The method as claimed in claim 1, wherein the blood sample being added to the pair of detecting electrode spread with a surfactant.

3. The method as claimed in claim 2, wherein the surfactant being selected from the group consists of cetyltrimethylammonium bromide (CTAB)—Triton X-100, TWEEN 20, TWEEN 40, TWEEN 60, Span 20, Carboxymethyl cellulose (CMC), sodium cholate and Sodium Dodecyl Sulphate (SDS).

4. The method as claimed in claim 1, wherein the voltage being inputted into the pair of detecting electrodes is between 1 and 3 volts.

5. A device for measuring a hematocrit comprising:
a detector comprising a pair of detecting electrode having a receiving portion and a contacting portion, wherein the receiver is used for accepting a blood sample; and
a measuring apparatus connecting to the contacting portion of the detector, and providing a voltage to the contactor based on a predetermined rule to obtain a hematocrit.

6. The device as claimed in the claim 5, wherein the measuring apparatus further comprises:
a pair of connector, each connector has a first terminal that is configured for connecting to the contacting portion of the detector;
a reference voltage source provides the voltage, and connects to a second terminal of one of the connecter to provide the voltage; and
a controller connects to a second terminal of another connecter and reference voltage source , and is configured for obtaining the hematocrit of the blood sample.

7. The device as claimed in the claim 6, wherein the detector further comprises:
a substrate is configured for disposing the detecting electrode thereon;
an insulating piece comprises a opening, is disposed on the substrate, partially covers above the detecting electrodes for a exposed portion at rear ends of the detecting electrodes being , wherein the opening is placed at a front end of the insulating piece for a exposed portion at front end of the detecting electrode; and
a cover is disposed on the insulating piece and comprises:
a conductive concave formed on a front end of the cover is overlapped corresponding to the opening of the insulating piece; and
a conductive hole formed on the cover corresponding to the opening of the insulating piece that form a pathway.

8. The device as claimed in the claim 7, wherein the substrate is made of non-conductive material selected from the group consists of: polyethylene terephthalate (PET), Polyvinylchloride (PVC), Flame Resistant glass fiber (FR-4), phosphatidylcholine (PC). Polyethylene (PE), Polypropylene (PP), Polystyrene (PS), Polyester sulphone, ceramic plate (CEM) and glass.

9. The device as claimed in the claim 5, wherein the detector comprises a surfactant coves above the receiving portion of the pair of the detecting electrode.

10. The device as claimed in claim 9, wherein the surfactant being selected from the group consists of cetyltrimethylammonium bromide (CTAB)—Triton X-100, TWEEN 20, TWEEN 40, TWEEN 60, Span 20, Carboxymethyl cellulose (CMC), sodium cholate and Sodium Dodecyl Sulphate (SDS).

11. The device as claimed in claim 5, wherein the voltage for detecting electrodes is provided in an range between 1 and 3 volts.
